(19) United States
(12) Patent Application Publication
(10) Pub. No.: US 2007/0049286 A1
(43) Pub. Date: Mar. 1, 2007

(54) System and method for determining position of mobile communication device by grid-based pattern matching algorithm

(76) Inventors: Tae Il Kim, Seoul (KR); Tae Joon Ha, Kyunggi-do (KR); Sung Hee Kim, Seoul (KR); Hyuk Jin Sohn, Seoul (KR); Won Seok Lee, Seoul (KR)

Correspondence Address: NIXON & VANDERHYE, PC, 901 NORTH GLEBE ROAD, 11TH FLOOR, ARLINGTON, VA, 22203, US

(21) Appl. No.: 10/576,831

(22) PCT Filed: Sep. 9, 2005
(86) PCT No.: PCT/KR05/02979

§ 371 Date: Apr. 24, 2006

(30) Foreign Application Priority Data
Sep. 17, 2004 (KR) 10-2004-0074421
Feb. 11, 2005 (KR) 10-2005-0011678
Sep. 1, 2005 (KR) 10-2005-0081293

(51) Int. Cl. H04Q 7/20

(52) U.S. Cl. 455/456.1

(57) ABSTRACT

Provided is a method and system for determining a position of a mobile communication device in a mobile communication network, the method including the steps of: dividing an area covered by the mobile communication network into a plurality of grids and collecting a first base station signal information with respect to each of the divided grids; storing and maintaining the collected first base station signal information in association with position information of the grids in a database; measuring a second base station signal information received by the mobile communication device; comparing the second base station signal information with the first base station signal information to find position information corresponding to the second base station signal information in the database; and generating final position information of the mobile communication device based on the position information found in the database.

### TECHNICAL FIELD

The present invention relates to a method and system for determining a position of a mobile communication device in a mobile communication network, and more particularly, to a system and method of determining a position of a mobile communication device by comparing property value for each signal, which is maintained for each plurality of grids, and signal information received from the mobile communication device.

### BACKGROUND ART

A location based service (LBS) is one type of mobile communication service using a position of a mobile communication device. The (LBS) indicates a service that simply and quickly provides various pieces of information associated with a position of a user while the user moves, via wireless communication. The LBS is used in checking and tracking a position in response to an accident or a disaster in the case an emergency occurs, quickly providing traffic information or surrounding region information, or providing various pieces of information associated with leisure such as a tourist showplace. In addition, the LBS is used in various fields such as mobile commerce based on position such as shopping for local specialties or memorials and impromptu ticketing or the administration of physical distribution (tracking a freight and vehicles).

There is a method using pseudo-random noise (PN) phase delay, a method depending on a cell radius, and a method of determining a position for each specifically divided unit in conventional methods of determining a position based on a mobile communication network.

In the method of determining a position based on a mobile communication network by using the PN phase delay, a relative time difference is converted into ‘a distance’ and a time difference of arrival (TDOA), an advanced forward link triangulation (AFLT), an enhanced observed time difference (E-OTD), and an observed time difference of arrival (OTDOA), which are methods of substituting for triangulation, are used. However, the position determination methods have a problem due to base station signal information reflected or dispersed being received via an indirect path in addition to direct base station signal information received from a base station or a repeater. The problem due to the indirect path is more serious than a noise, and a solution for the problem is urgently needed. Also, in the base station signal information received from the base station, since a timepiece of the repeater is not precise or the property of the system of the repeater is different from each other repeater, there is a great possibility of generating a problem of variability of PN phase delay of the repeater. It may act as an important variable in determining a position of a mobile, communication device whether base station signal information received by the mobile communication device is received from the base station or the repeater.

There is Cell ID method and Enhanced Cell ID (EX, CITA+RXLEV) method, which depend on the radius of a cell. Since the methods largely depend on the radius of a cell, there is a great error in position information of a mobile communication device in an area whose cell radius is large, such as the outskirts of town and a screened area. Also, since the PN strength of base station signal information received from each base station is variable, there is a problem of not sufficiently satisfying the accuracy that is initially required.

There are several conventional methods for applying RP fingerprint. For example, there is “Radar” of Microsoft Corporation, which is used in indoor positioning based on an AP of WLAN₅ and DCM method based on GSM handset. The described technology stores received signal strength as user position information and selects a position determined to be the most accurate by comparing with the stored data in the case a positioning is requested. For example, there is “RadioCamera” of U.S. Wireless Corporation, which maintains information for each degree of angle of received signal strength inputted into one array antenna for use in positioning.

However, the conventional position determination technology has a technical limit that can not find a position of a building to which a relevant device belongs (is located in), and, therefore, a position determination method that can precisely determine a position of a building for a building is not offered as software.

### DISCLOSURE OF INVENTION

### Technical Goals

To solve the problems of conventional methods, the present invention provides a method and system which determine a position of a mobile communication device by using conventional base station signal information as it is, thereby minimizing the cost of constructing the system and any other additional costs.

The present invention also provides a method and system which can reflect changes of the surrounding environment of a base station to continuously provide precise device position information.

The present invention also provides a method and system which determines a position of a mobile communication device in a large scale building, and distinguishes the inside of the building from the outside and, in addition, between stories of the building, thereby precisely determining a position of a device.

The present invention also provides a method and system which can efficiently compute position result of a building to which a mobile communication device belongs by setting an appropriate error range in the case base station signal information is distorted due to the surrounding environment of the building.

The present invention also provides a method and system which can continuously provide precise position information by reflecting changes of the communication network due to the installation or change of a base station or a repeater.

### Technical Solutions

According to an aspect of the present invention, there is provided a method of determining a position of a mobile communication device in a mobile communication network including a plurality of base stations, including the steps of: dividing an area covered by the mobile communication network into a plurality of grids and collecting a first base station signal information with respect to each of the divided grids; storing and maintaining the collected first base station signal information in association with position information of the grids in a database; measuring a second base station signal information received by the mobile communication device; comparing the second base station signal information with the first base station signal information to search position information corresponding to the second base station signal information from the database; and generating final position information of the mobile communication device based on the position information found in the database.

According to another aspect of the present invention, there is provided a method of determining a position of a building to which a mobile communication device belongs, including the steps of: collecting first base station signal information with respect to each building; storing and maintaining the collected first base station signal information in association with identification information of the buildings in a pattern matching database; measuring second base station signal information received by the mobile communication device; searching the pattern matching database by the second base station signal information to find a base station set similar to the second base station signal information; and determining a position of a building corresponding to the found base station set as the position of the building to which the mobile communication device belongs in the case the property of the second base station signal information is corresponding to a predetermined property range of the found base station set.

### BRIEF DESCRIPTION OF DRAWINGS

FIG. 1 is a diagram illustrating an example of a configuration of a network including a position determination system according to the present invention and a conventional mobile communication network;

FIG. 2 is a diagram illustrating an area covered by a mobile communication network, which is divided into a plurality of grids, and position information shown for each grid, according to a preferable embodiment of the present invention;

FIG. 3 is a flow chart illustrating a position determination method according to a preferable embodiment of the present invention;

FIG. 4 is a diagram illustrating an example of a database according to the present invention;

FIG. 5 is a diagram illustrating another example of the database according to the present invention, in which first base station signal information includes a relative PN phase difference;

FIG. 6 is a diagram illustrating a method of determining a relevant grid from a received signal of a mobile communication device;

FIG. 7 is a diagram illustrating a process of generating final position information of a mobile communication device by pattern-matching second base station signal information with a database, according to the present invention;

FIG. 8 is a diagram illustrating an example of a configuration of an environment for applying a method of determining a position of a mobile communication device, according to the present invention;

FIG. 9 is a diagram illustrating a method of determining a position by distinguishing the inside of a building from the outside of the building according to another embodiment of the present invention;

FIG. 10 is a diagram illustrating a method of determining a position by distinguishing between stories of a building according to still another embodiment of the present invention;

FIG. 11 is a flowchart illustrating an example of embodying a position determination method according to the present invention, coupled with a GPS position determination method;

FIG. 12 is a block diagram illustrating an internal configuration of a position determination system according to a preferable embodiment of the present invention;

FIG. 13 is a diagram illustrating an example of base station signal information collected for determining a position of a building to which a mobile communication device belongs to, according to an embodiment of the present invention;

FIG. 14 is a diagram illustrating an example of a pattern matching database according to an embodiment of the present invention;

FIG. 15 is an operation flow chart illustrating a method of determining a position of a building to which a mobile communication device belongs, according to an embodiment of the present invention; and

FIG. 16 is a block diagram illustrating a system for determining a position of a building to which a mobile communication device belongs, according to an embodiment of the present invention.

### BEST MODE FOR CARRYING OUT THE INVENTION

Hereinafter, a position determination method and system according to the present invention will be described with reference to the attached drawings.

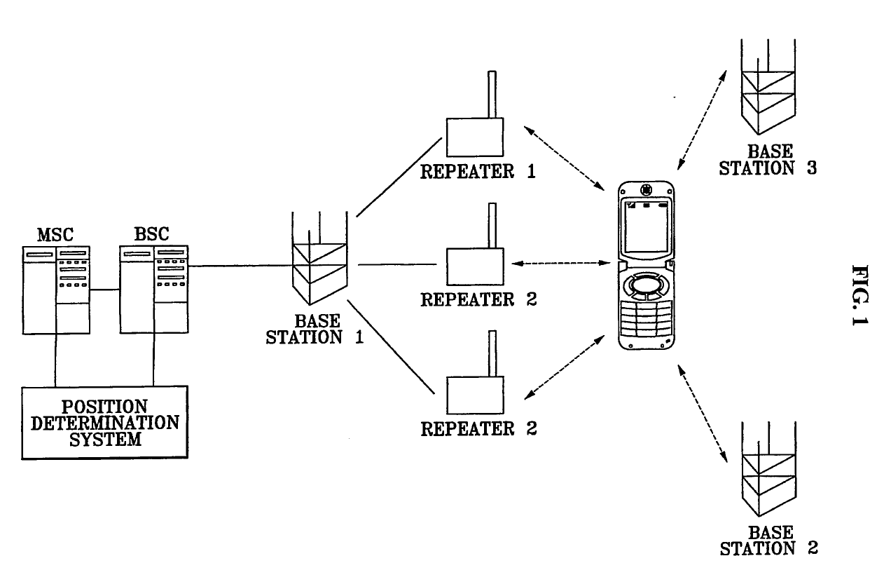

FIG. 1 is a diagram illustrating an example of a configuration of a network including a position determination system according to the present invention and a conventional mobile communication network.

Referring to FIG. 1, a mobile communication network includes a plurality of base stations, and a mobile communication device of a user receives base station signal information from the plurality of the base stations, respectively. The “plurality of the base stations” includes a reference base station with which the mobile communication device is currently communicating with and peripheral base stations. The mobile communication device continuously receives a plurality of pieces of base station signal information from not only a base station in a cell in which the mobile communication device is located but also base stations of peripheral cells. The mobile communication device transmits the received base station signal information to a position determination system according to the present invention, and the position determination system determines a position of the mobile communication device by comparing base station signal information stored in a database with the base station signal information received from the mobile communication device. Also, it is understood as not only the position determination system directly receives the base station signal information from the mobile communication device but also the base station signal information received from the mobile communication device is stored in a certain system (or space) of the communication network and the position determination system accesses the certain system to obtain the base station signal information that the base station signal information received by the mobile communication device is measured.

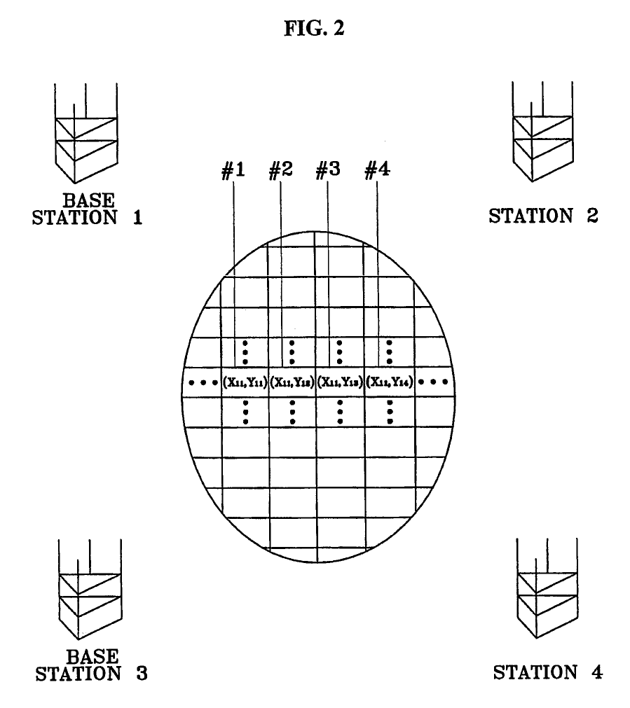

FIG. 2 is a diagram illustrating an area covered by a mobile communication network, which is divided into a plurality of grids, and position information shown for each grid, according to a preferable embodiment of the present invention. The grid is a unit made by dividing two-dimensional geographic information (longitude and latitude) by a standard length. In this case, the standard length may be from several tens of meters to several hundreds of meters. On the other hand, the grid may be a unit by dividing three-dimensional geographic information (longitude, latitude, and altitude) by a standard length. The position information may be set as desired for each grid as a representative value or a certain value existing in the grid.

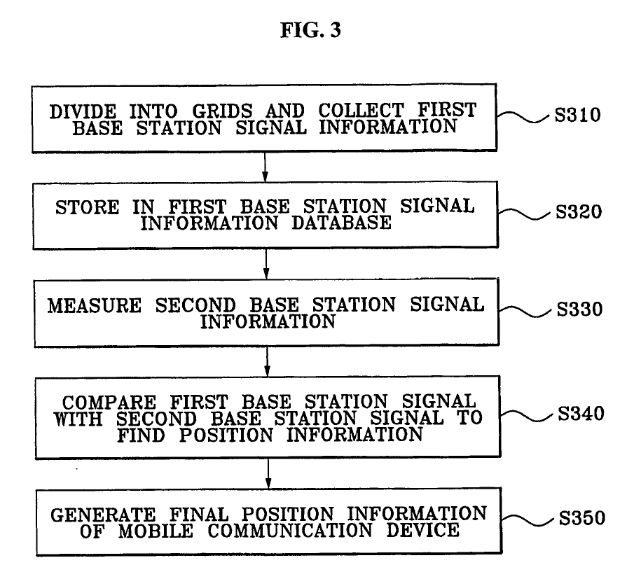

FIG. 3 is a flow chart illustrating a position determination method according to a preferable embodiment of the present invention. Hereinafter, a process performed for each step will be described in detail with reference to FIG. 3.

In the step S310, an area covered by a mobile communication network is divided into a plurality of grids and first base station signal information with respect to each of the divided grids is collected.

According to the present invention, an area covered by a plurality of base stations is divided into a plurality of grids, which may be divided into two dimensions or three dimensions. Namely, a building may be divided into grids different from each other according to the front, back, side of the building, the same building may have grids different from each other for each story, and the same story may be divided into grids different from each other according to a position. Varied embodiments of the division of grids will be described later.

In the present step, the first base station signal information is collected with respect to each of the divided grids. In a certain position in each grid, a base station signal may be received from at least one base station, and the received information is collected as base station signal information for identifying each base station.

For example, the first base station signal information may include at least one of pseudo-random noise (PN) phase, PN offset, PN phase delay, and PN strength.

In the step S320, the first base station signal information collected at the previous step is stored and maintained in a database in association with position information of each grid.

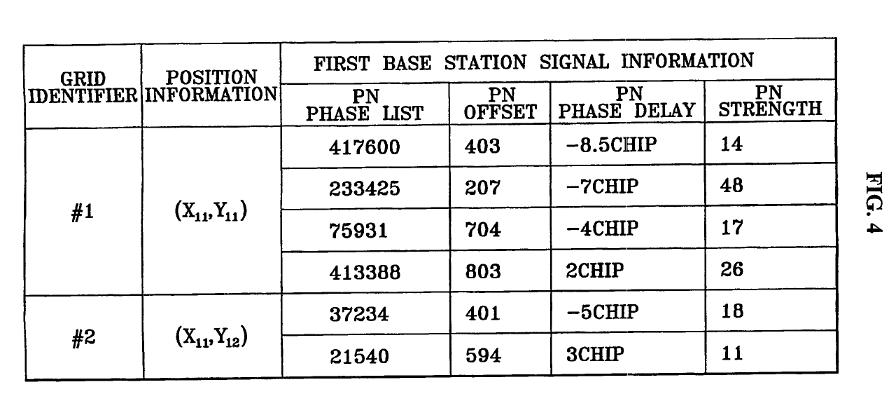

FIG. 4 is a diagram illustrating an example of a database according to the present invention. Referring to FIG. 4, at least one piece of base station signal information may be stored for each piece of position information of the grid. In storing the first base station signal information, for example, base station signal information from a small number of base stations may have several base stations whose received PN strength is strong or a repeater may be stored or all base station signal information may be stored. Since it is sufficient if each grid can be distinguished by the number of base station signals to be stored, the number of the base station signals of each grid may be determined to be different from each other or varied with embodiments. In FIG. 4, base station signal information with respect to a grid # 1 having position information (XI1, YH), received from four base stations and base station signal information with respect to a grid #2 having position information (XI1, Y12), received from two base stations are stored, respectively. As described above, according to the present invention, the first base station signal information is stored and maintained as a property value of each signal maintained for each of the plurality of grids.

In the step S330, second base station signal information received by the mobile communication device is measured. In the method of determining a position of a mobile communication device, according to the present invention, the base station signal information received by the mobile communication device is used in determining a position of the mobile communication device located in the current mobile communication network. For example, the second base station signal information may include at least one of PN phase, PN offset, PN phase delay, and PN strength.

In the step S340, the first base station signal information stored in the database is compared with the measured second base station signal information to search position information corresponding to the second base station signal information from the database. Namely, a position of a grid having information most similar to the information received by the mobile communication device according to the present invention is retrieved from the database by using a pattern matching method, thereby obtaining identification information of each grid.

In the step S350, final position information of the mobile communication device is generated based on the position information found in the database. In generating the final position information, if there is second position information obtained by using another method in addition to the position determination method according to the present invention, the mean of the position information and the second position information may be obtained and determined to be the final position information or a result of multiplying each position information is multiplied a predetermined weight may be determined to be the final position information.

As an example according to the present invention, the steps S310 and S320 may be not directly performed by the position determination system according to the present invention. Accordingly, in the case a database storing the first base station signal information is previously constructed, the position determination system may perform only from step S330 and subsequent steps by searching and referring to the database.

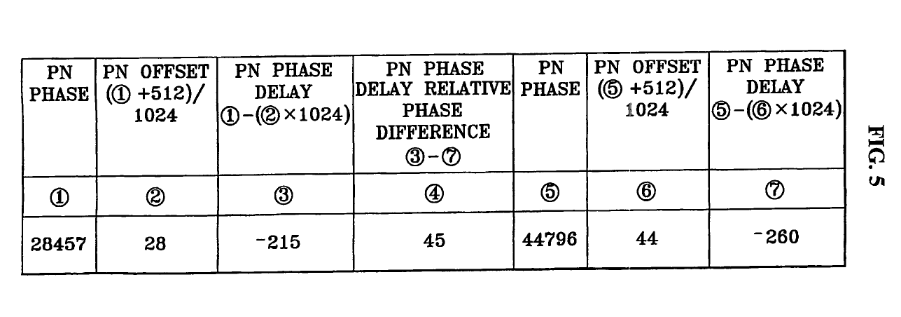

FIG. 5 is a diagram illustrating another example of the database according to the present invention, in which the first base station signal information includes a relative PN phase difference.

In FIG. 5, for example, a method of obtaining a relative phase difference 45® between two PN phases such as 28457® and 44796® is illustrated. Since parameters such as PN phase and PN phase delay are variable in time but a value of “a relative phase difference” is kept constant regardless of time, the relative phase difference may be used as a key parameter for distinguishing each grid.

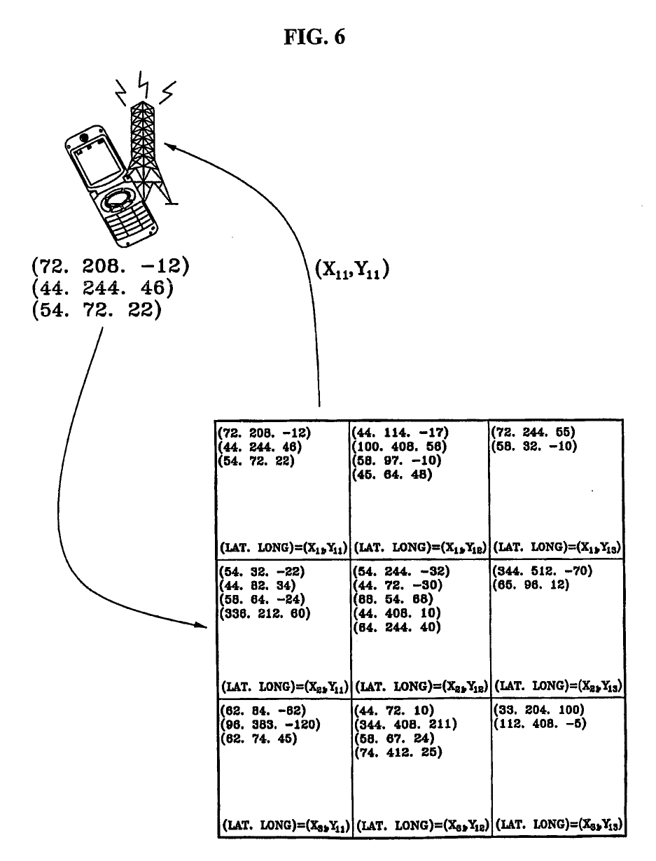

FIG. 6 is a diagram illustrating a method of determining a relative grid from a received signal (the second base station signal information) of the mobile communication device.

As illustrated in FIG. 6, the database stores the first base station signal information with respect to all nine grids in the form of a grip map.

For example, the content of a grid of a first line and a first row is as follows. PN offsets 72, 208, 44, 244, 54, and 72 are received from the data (72, 208, −12), (44, 244, 46), and (54, 72, 22) to a relative grid, and relative phase differences are stored having −12, 46, and 22, respectively. Accordingly, when the second base station signal information corresponding to the first base station signal information is received from the mobile communication device, it may be determined that the mobile communication device is located in the grid in the first line and the first row. Therefore, position information (X1 1, Y1 1) of the grid is determined to be the final position information of the mobile communication device.

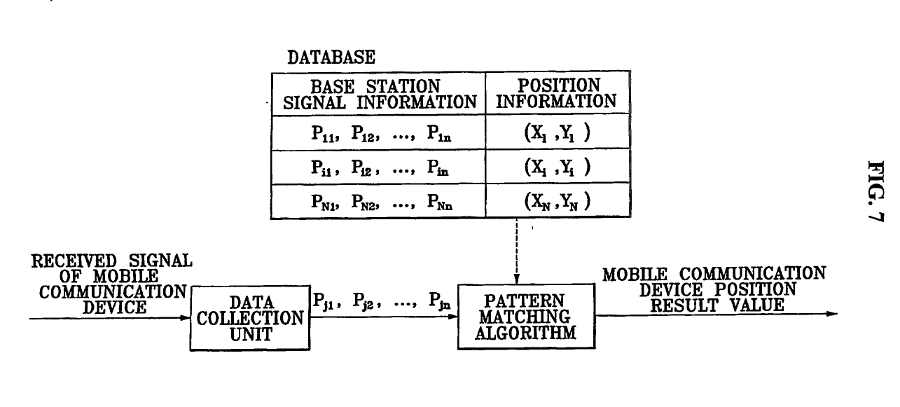

FIG. 7 is a diagram illustrating a process of generating final position information of a mobile communication device by pattern-matching second base station signal information from a database, according to the present invention.

As illustrated in FIG. 7, a received signal of the mobile communication device is inputted via a data collection unit, and the data collection unit configures a series of pattern sets (PjI, Pjw, . . . , Pjn) with respect to base station signal information from the received signal. The pattern sets, used to match the base station signal information with the position information, have a property that the pattern sets must correspond to an exclusive key value. To satisfy the condition, for example, a relative phase difference of PN delay and PN strength received from a base station are managed as a set found in the database, thereby forming a series of a pattern. The pattern configured by the data collection unit is compared with the database managing the position information in the system by using a pattern matching algorithm, thereby computing position information corresponding to the most similar base station signal information as a result value.

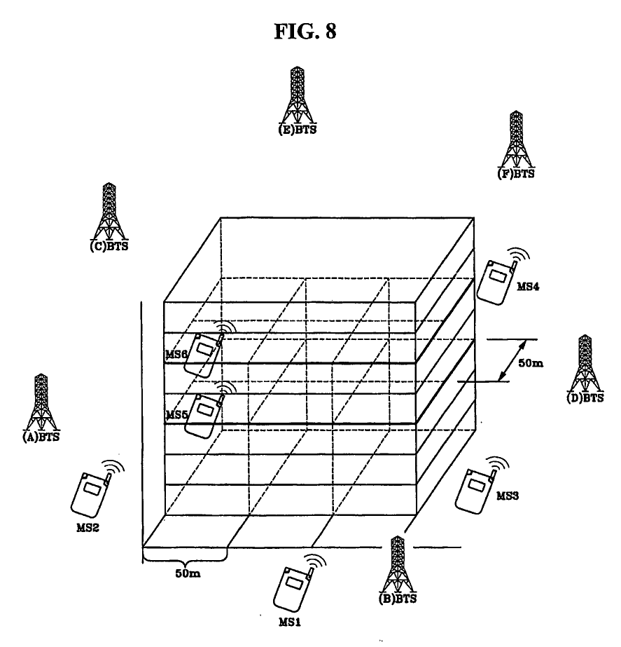

FIG. 8 is a diagram illustrating an example of the configuration of an environment for applying a method of determining a position of a mobile communication device, according to the present invention. Under a mobile communication environment using a high frequency band, in the case there are objects on the ground, such as buildings, a base station signal received from the base station by the mobile communication device shows a great difference. Accordingly, as illustrated in FIG. 8, the mobile communication device position may be determined according to whether the mobile communication device located inside or outside the building, or if the mobile communication device is located outside of the building in the front/back/side, or may be determined according to which story of the building the mobile communication device is located in. In FIG. 8, centered around the building, base transceiver stations (BTSs) are diversely disposed in (A), (B), (C), (D), (E), and (F), mobile communication devices MS1, MS2, MS3, and MS4 are located in the four sides of the building, mobile communication device MS5 is located in a fourth story of the building, and the mobile communication device MS6 is located in a sixth story, respectively. For example, each story of the building is divided into a section of 50×50 m.

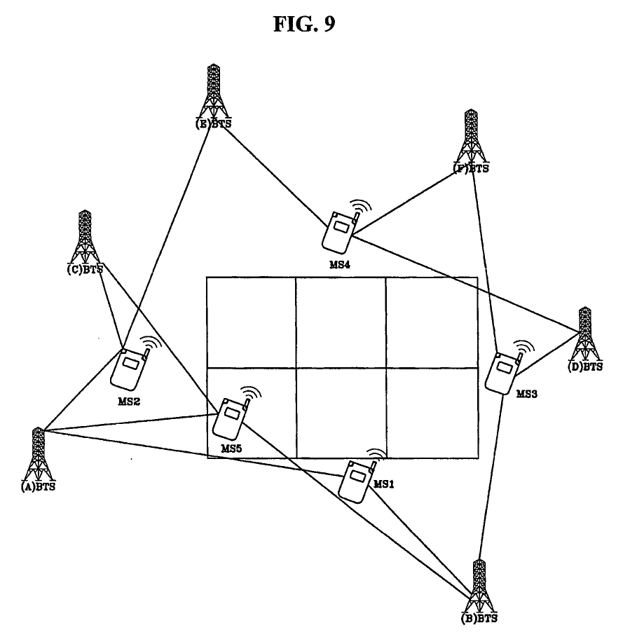

FIG. 9 is a diagram illustrating a method of determining a position by distinguishing the inside of a building from the outside of the building according to another embodiment of the present invention. As illustrated in FIG. 9, the mobile communication device MS1 determines BTSs (A) and (B) as base stations which can transmit/receive and configures a pattern set (A, B) defining a grid from information received from the mobile communication device MS1. The mobile communication device MS2 also configures a pattern set (A, C, E). The mobile communication devices MS3, MS4, and MS5 also configure pattern sets (B, D, F), (D, E, F), and (A, B, C), respectively. The pattern sets are stored as the first base station signal information identifying grids different from each other, in the database for constructing a grip map. If a position of a mobile communication device that actually requests a position determination service is MS1, since a pattern set may be formed as (A, B), latitude and longitude (lat, long) of a relevant grid may be converted into a result value of a relevant position by using the pattern matching algorithm.

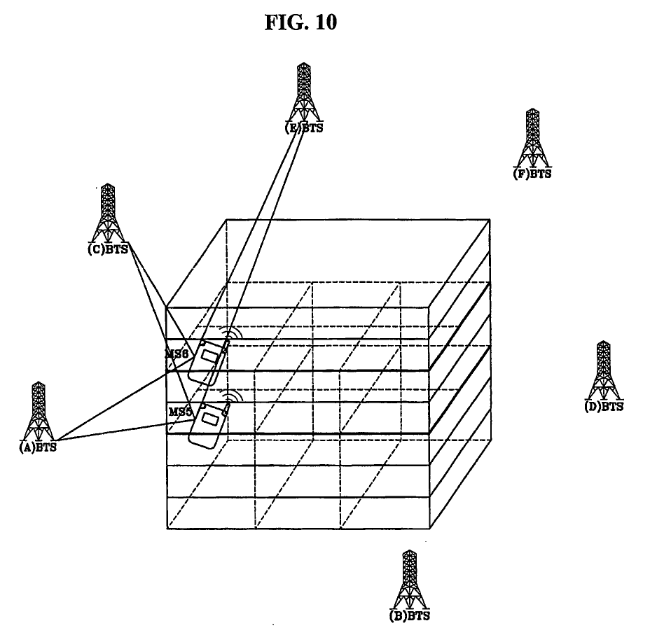

FIG. 10 is a diagram illustrating a method of determining a position by distinguishing between stories of a building according to still another embodiment of the present invention. The mobile communication devices MS5 and MS6 which are located in different stories of the same building communicate with the BTS¹(A), (C), and (E) as the base station which can transmit/receive. Accordingly, both of them form (A, C, E) as a pattern set for dividing a grid. However, since a relative phase difference of PN phase is divided into D5 and D6 due to a physical distance existing between stories, the pattern set dividing a grid may be formed to be different from each other as (A, C, E, D5) and (A, C, E, D6), respectively. Accordingly, due to the different pattern set, the position information of the grid searched from the database by using the pattern matching algorithm may also include altitude information in addition to latitude and longitude (lat, long, floor). For this, the database stores the base station signal information differentiating each other according to the altitude information, thereby determining the grid.

As illustrated in FIGS. 8 through 10, according to the present invention, in the case a mobile communication area is divided into a plurality of grids, the inside and outside of a building and the story of the building may be divided into the grids. Accordingly, to compare with a two-dimensional grid divided into latitude and longitude, a three-dimensional grid additionally provides altitude information to users as position information, thereby providing precise position information.

The position determination method based on grid pattern mapping (GPM) described in the previous embodiments, has a defect in that it can not quickly respond to a change in the communication network. For example, in the case a new base station or a repeater is installed in a mobile communication network, the direction of reflection of an electric wave, the configuration of a base station is changed, or a change occurs in a geomorphic object such as a building, base station signal information corresponding to surrounding grids is changed. Accordingly, the position determination method according to the present invention uses a self learning methodology (SLM), thereby continuously providing precise position information by reflecting changes in the communication network on the database.

For this, hereinafter, as another embodiment of the present invention, the steps of updating base station signal information in a grid by using a weight average method will be described.

The position determination method according to the present invention includes the step of determining second position information of a mobile communication device by a predetermined second position determination method. The “second position determination method” indicates another position determination method that is not the described GPM method. For example, the second position information may be determined by using GPS receiving equipment.

Next, the step of measuring third base station signal information received by a second mobile communication device with respect to the second position information is included. Namely, a base station signal is measured with respect to each position determined by the second position determination method and stored as third base station signal information.

The step of updating the first base station signal information stored in the database based on the measured third base station signal information is included. To update, first position information corresponding to the second position information is identified and first base station signal information stored in association with the first position information is found and updated with the third base station signal information.

Equation (1) is a method of updating the first base station signal information stored in a first database in association with the first position information corresponding to the second position information based on the third base station signal information in the weight average method according to the present invention.

In this case, the updated and newly stored first base station signal information (a′) may be computed as Equation (1) by applying a predetermined weight to the existing first base station signal information (a) and newly reported third base station signal information (b).
a′=w*a+(1−w)*b(0<w<1) Equation (1)

a′: first base station signal information that is updated and stored

w:=a weight

a: first base station signal information

b: third base station signal information

As described above, according to the present invention, base station signal information that is varied with a change in the communication network is continuously updated in the database, thereby improving the precision of determining a position of a mobile communication device by grid based SLM (Self Learning Methodology).

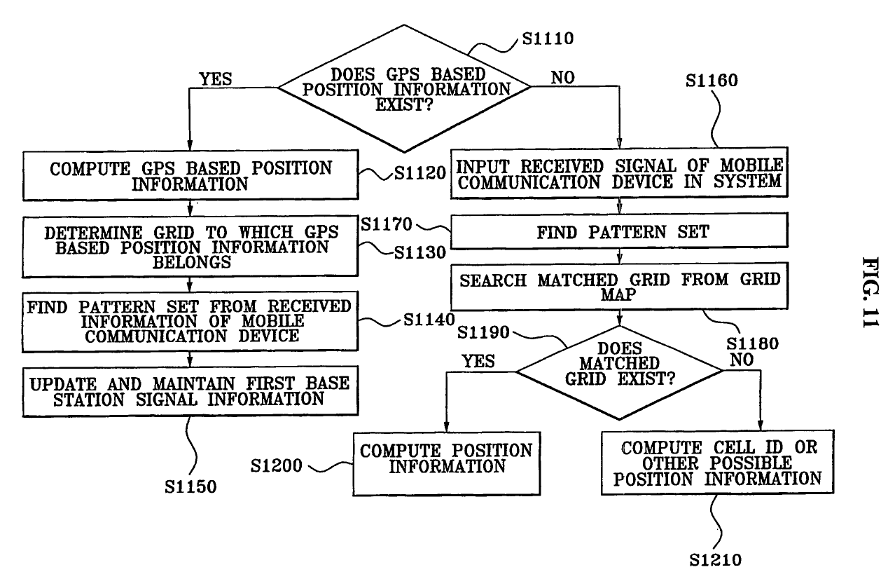

FIG. 11 is a flowchart illustrating an example of embodying the position determination method according to the present invention, coupled with a GPS position determination method.

When a request of determining a position is inputted from a mobile communication device, a determination if GPS based position information exists in relevant received information (S1 110) is made. If the GPS based position information exists, the GPS based position information is computed as a result value (S1 120), and a grid to which the position information belongs is determined to be second position information (S1 130). A pattern set is found from the information received by the mobile communication device with respect to the determined grid (S1 140) and stored as first base station signal information to be updated and maintained (S1150).

If the GPS based position information does not exist, a pattern set from the received information of the relevant mobile communication device (S1160 and S1170) is compared with a grid map database to locate a matching grid (S1180). If a matching grid exists, position information is computed (S1200). If a matching grid does not exist, a result value is computed from cell-ID or other possible position information S1210.

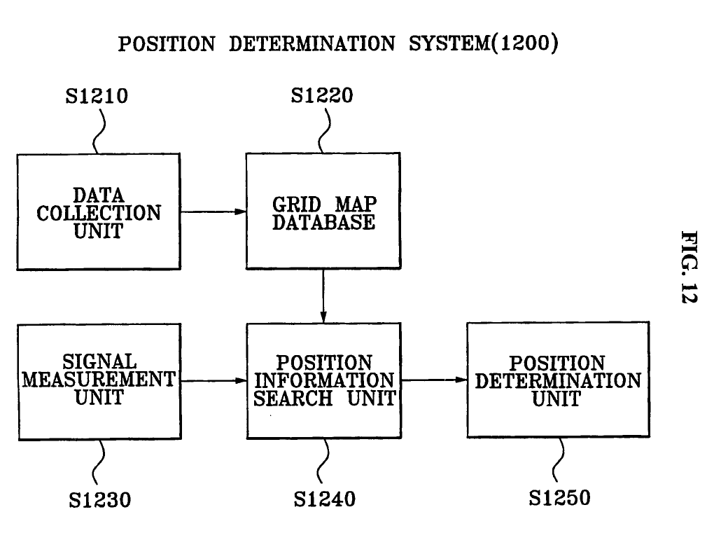

FIG. 12 is a block diagram illustrating the internal configuration of a position determination system according to a preferable embodiment of the present invention. The position determination system 1200 according to the present invention includes a data collection unit 1210, a grid map database 1220, a signal measurement unit 1230, a position information search unit 1240, and a position determination unit 1250. Hereinafter, the function of each element will be described.

The data collection unit 1210 divides an area covered by a mobile communication network into a plurality of grids and collects first base station signal information with respect to the divided grid. According to the present invention, the grid may be two-dimensions or three-dimensions, and it may be divided into grids separated according to the inside and outside of a building and the story of the building.

The grid map database 1220 stores and maintains the collected first base station signal information in association with position information of the grid. For example, the grid map database has a configuration as shown in FIGS. 4 through 6. If the grid is two-dimensions, latitude and longitude are provided as position information, and if the grid is three-dimensions, altitude information may be added to the latitude and longitude.

The signal measurement unit 1230 measures second base station signal information received by the mobile communication device. As an example of the second base station signal information, similar to the first base station signal information, at least one of PN phase, PN offset, PN phase delay, and PN strength may be included.

The position information search unit 1240 compares the first base station signal information and the second base station signal information to search position information corresponding to the second base station signal information from the database. A predetermined pattern matching algorithm may be used for searching the position information.

The position determination unit 1250 generates final position information of the mobile communication device based on the position information found in the database. In generating the final position information, optimal position information may be generated by averaging the position information according the present invention and position information according other position determination methods or weight computation.

Up to this point, the position determination system according to the present invention has been described. Since the technical content described in the previous position determination method may be applied as is to the configuration of the system, a more detailed description will be omitted. The position determination system according to the present invention may be disposed as a server flanked with a base station, a base station controller, or a base station relay. The installation position is not limited as long as base station signal information can be received. For example, to consider management, investment, and efficiency, the position determination system according to the present invention may be independently connected to a conventional core network (or a server system) of a communication network.

As another embodiment of the present invention, taking into consideration resource environments of a mobile communication device, such as a processor, memory, and RF module are rapidly being improved, the configuration of the position determination system shown in FIG. 12 is installed in the mobile communication device to operate within the mobile communication device, thereby directly determining a position of the mobile communication device by using base station signal information received from each base station, without help of the surrounding servers via the mobile communication network. Namely, the position determination system is installed in the mobile communication device instead of constructing the position determination system in the mobile communication network as an additional platform, thereby reducing the load on the system, which may occur due to messages transmitted and received between the mobile communication device and the surrounding servers in determining the position of the mobile communication device, and reducing the cost for mobile communication providers to introduce and activate location based service (LBS) in a short time.

The described method and system for determining a position of a mobile communication device based on grid pattern matching may be applied to determine a position of a building to which the mobile communication device belongs, especially when a grid is already established for each building. Hereinafter, as an embodiment of the present invention, a method and system for determining a position of a building to which a mobile communication device belongs, based on pattern matching will be described.

In the method of determining the position of the building to which the mobile communication device belongs, according to the present invention, a constructed pattern matching database is used. In the pattern matching database, base station signal information collected from the mobile communication device is stored. For example, in the pattern matching database, base station ID, a range of PN phase delay, a range of PN strength, a series of a base station set, latitude, longitude, and addresses of buildings may be stored.

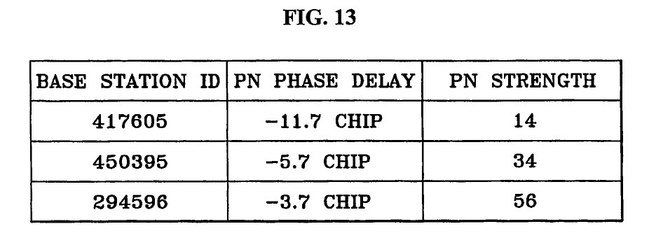

FIG. 13 is a diagram illustrating an example of base station signal information collected for determining a position of a building to which a mobile communication device belongs, according to an embodiment of the present invention.

Referring to FIG. 13, base station ID, PN phase delay, and PN strength are collected for each base station in order to determine the position of the building to which the mobile communication device belongs.

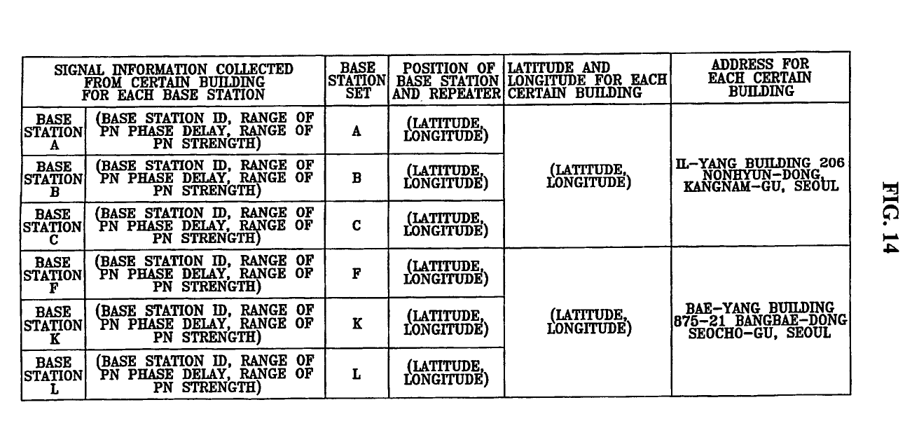

FIG. 14 is a diagram illustrating an example of a pattern matching database according to an embodiment of the present invention.

Referring to FIG. 14, in the pattern matching database, collected base station signal information, base station set, and information on latitude and longitude of base stations and repeaters are stored for each building in association with identification information of the building. For example, the identification information may include an address of the building, coordinates of the building, such as latitude and longitude, or the name of the building.

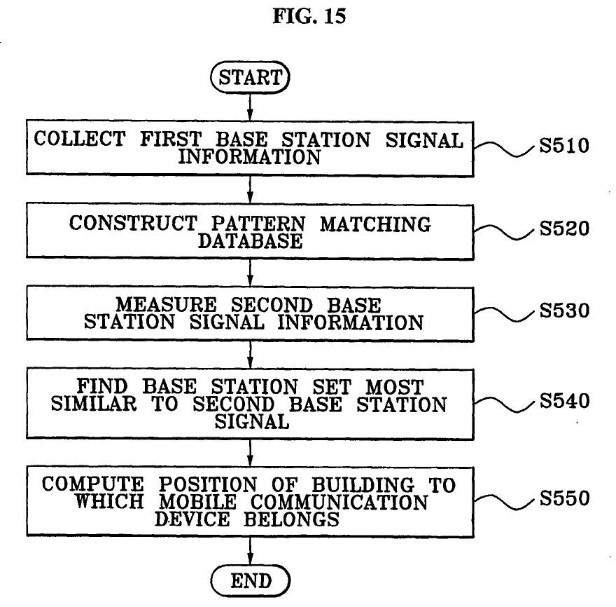

FIG. 15 is an operation flowchart illustrating the method of determining a position of a building to which a mobile communication device belongs, according to an embodiment of the present invention.

Referring to FIG. 15, first base station signal information with respect to a relevant building is collected for each building (S510).

In this case, the first base station signal information may include base station ID, PN phase delay, and PN strength. As described above, the first base station signal information collected for each building may construct a certain pattern for each building and form a series of a base station set.

For example, the first base station signal information may be collected as shown in FIG. 13.

Also, the collected first base signal information is stored in a pattern matching database in association with an address of the building (S520).

The first base station signal information constructed for each building is used as a key value that can distinguish each building. Particularly, PN phase delay, PN strength, and base station set received from a plurality of base stations function as important keys.

For example, the pattern matching database may be constructed as illustrated in FIG. 14.

Also, second base station signal information received by the mobile communication device is measured (S530).

In this case, the second base station signal information may include at least one of PN phase, PN offset, PN phase delay, and PN strength.

Also, a base station set most similar to the second base station signal information is found by searching the pattern matching database by using the second base station signal information (S540).

For example, the most similar base station set may be found by searching the base station ID and base station set stored in the pattern matching database based on the base station ID, PN phase delay, PN strength, and the series of base station set included in the second base station signal information.

Accordingly, a base station set corresponding to a pattern most similar to measured second base station signal information from patterns stored in the pattern matching database is found.

In this case, PN phase delay and PN strength may be important factors for comparing the pattern stored in the pattern matching database and the second base station signal.

Also, in the case the property of the second base station signal is corresponding to a predetermined property range of the found base station set, a position of a building corresponding to the found base station set is computed as the position of the building to which the mobile communication device belongs (S 550).

In this case, the predetermined property range of the base station set may include PN phase delay and PN strength. In this case the PN phase delay range may be determined to be within a predetermined range including the maximum value and the minimum value of PN phase delays from each base station in the found base station set, and the PN strength range may be determined within a predetermined range including the maximum value and the minimum value of the PN strengths for each base station in the found base station set.

For example, in the case the property of the second base station signal has an error such as 2 chips more than the minimum value and the maximum value of the PN phase delays of each of the base stations in the found base station set, and an error of approximately 2.5 dB more than the minimum value and the maximum value of the PN strengths of each of base stations in the found base station set, the property may be determined to be within a predetermined property range.

The described method of determining the position of the building is a very useful method because the changes of the PN phase delay and the PN strength is not large in the building and the base station set is divided for each building.

Also, in the position determination method explained via FIG. 15, the pattern matching database may be updated by newly collected base station signal information. In the case the base station signal information updated and newly stored is a′, existing base station information is a, and a newly collected base station information is b, the updated base station signal may be computed as Equation (1) by using a weight w.

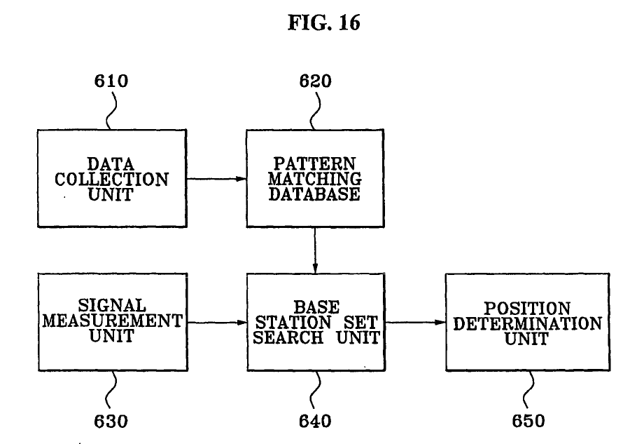

FIG. 16 is a block diagram illustrating a system for determining a position of a building to which a mobile communication device belongs, according to an embodiment of the present invention.

Referring to FIG. 16, the system for determining the position of the building to which the mobile communication device belongs, according to an embodiment of the present invention, includes a data collection unit 610, a pattern matching database 620, a signal measurement unit 630, a base station set search unit 640, and a position determination unit 650.

The data collection unit 610 collects first base station signal information with respect to a relevant building for each building.

The pattern matching database 620 stores and maintains the collected first base station signal information in association with identification information of the building.

The signal measurement unit 630 measures second base station signal information received by the mobile communication device.

The base station set search unit 640 finds a base station set most similar to the second base station signal by searching the pattern matching database by using the second base station signal.

The position determination unit 650 computes a position of a building corresponding to the found base station set as the position of the building to which the mobile communication device belongs in the case the property of the second base station signal is corresponding to a predetermined property range of the found base station set.

Since content that is not described in association with the position determination system via FIG. 16 can be applied, as previously described, to the embodiments associated with the position determination methods for determining the position of the building to which the mobile communication device belongs, hereinafter it will be omitted.

The method of determining a position of a mobile communication device and a building to which a mobile communication device belongs, according to the present invention, may be embodied as a computer readable medium including a program instruction for executing various operations realized by a computer. The computer readable medium may include a program instruction, a data file, and a data structure, separately or cooperatively. The program instructions and the media may be those specially designed and constructed for the purposes of the present invention, or they may be of the kind well known and available to those skilled in the art of computer software arts. Examples of the computer readable media include magnetic media (e.g., hard disks, floppy disks, and magnetic tapes), optical media (e.g., CD-ROMs or DVD), magneto-optical media (e.g., floptical disks), and hardware devices (e.g., ROMs, RAMs, or flash memories, etc.) that are specially configured to store and perform program instructions. The media may also be transmission media such as optical or metallic lines, wave guides, etc. including a carrier wave transmitting signals specifying the program instructions, data structures, etc. Examples of the program instructions include both machine code, such as produced by a compiler, and files containing high-level languages codes that may be executed by the computer using an interpreter. The hardware elements above may be configured to act as one or more software modules for implementing the operations of this invention.

As described above, though the method and system for determining a position of a mobile communication device and the method and system for determining a position of a building to which a mobile communication device belongs are described centered on a synchronous network, the technical scope of the present invention is not limited to the synchronous network and may be applied as is to an asynchronous network. In the case of the asynchronous network, round trip time delay such as timing advance or round trip time may be used instead of PN phase delay.

While this invention has been particularly shown and described with reference to preferred embodiments thereof, various changes in form and details may be made therein without departing from the spirit and scope of the invention as defined by the appended claims.

Therefore, the scope of the invention is defined not by the detailed description of the invention but by the appended claims, and all differences within the scope will be construed as being included in the present invention.

### INDUSTRIAL APPLICABILITY

According to the present invention, since a position of a mobile communication device is determined based on base station signal information received from a base station by the mobile communication device, the position of the mobile communication device may be determined in the case of a mobile communication device that is not equipped with a GPS receiving device or a mobile communication network without additional hardware-based equipment.

According to the present invention, precise position information may be continuously provided with little expense by continuously and automatically reflecting changes of network, according to additional installation and movement of a base station or a repeater and changes of geographical objects.

According to the present invention, not only two-dimensional position information including latitude and longitude but also in three dimensions by including altitude information is provided, thereby improving the precision of the position information of a mobile communication device.

According to the present invention, the method and system may be applied to a mobile communication network based on not only a synchronous network but also an asynchronous network and may be applied to a mobile communication network including repeaters.

1. A method of determining a position of a mobile communication device in a mobile communication network including a plurality of base stations, comprising the steps of:
dividing an area covered by the mobile communication network into a plurality of grids and collecting a first base station signal information with respect to each of the divided grids;
storing and maintaining the collected first base station signal information in association with position information of the grids in a database;
measuring a second base station signal information received by the mobile communication device;
comparing the second base station signal information with the first base station signal information to find position information corresponding to the second base station signal information in the database; and
generating final position information of the mobile communication device based on the position information found in the database.

2. The method of claim 1, wherein the first base station signal information includes at least one of pseudo-random noise phase, pseudo-random noise offset, pseudo-random noise phase delay, and pseudo-random noise strength.

3. The method of claim 1, wherein the grids are three-dimensionally divided, the position information includes altitude information, and the first base station signal information varies with the altitude information.

4. The method of claim 3, wherein the altitude information is determined based on relative phase difference of the pseudo-random noise offsets with respect to the plurality of base stations.

5. The method of claim 1, further comprising the steps of:
determining second position information by a predetermined second position determination method;
measuring third base station signal information received by a second mobile communication device with respect to the second position information; and
updating the first base station signal information stored in the database based on the measured third base station signal information.

6. The method of claim 5, wherein the second position determination method is performed by a GPS receiving device.

7. The method of claim 5, wherein the updated first base station information (a′) is determined according to a′=w*a+(1−w)*b (a: first base station information, b: third base station information, and 0<w<1).

8. The method of claim 1, wherein the grids are divided according to the inside and outside of a building and a story of the building.

9. The method of claim 1, wherein the grids are corresponding to each building and the position information includes identification information of the buildings.

10. A method of determining a position of a mobile communication device based on a grid map database in a mobile communication network including a plurality of base stations, comprising the steps of:
measuring a second base station signal information received by the mobile communication device;
comparing the second base station signal information with the first base station signal information to find position information corresponding to the second base station signal information in the grid map database; and
generating final position information of the mobile communication device based on the position information found in the grid map database,
wherein, the grid map database stores first base station signal information in association with position information of grids and an area covered by the mobile communication network is divided into the grids.

11. A system for determining a position of a mobile communication device in a mobile communication network including a plurality of base stations, comprising:
a data collection unit dividing an area covered by the mobile communication network into a plurality of grids and collecting first base station signal information with respect to the divided grids;
a grid map database storing and maintaining the collected first base station signal information in association with the position information of the grid;
a signal measurement unit measuring second base station signal information received by the mobile communication device;
a position information search unit comparing the second base station signal information with the first base station signal information to find position information corresponding to the second base station signal information in the database; and
a position determination unit generating final position information of the mobile communication device based on the position information found in the database.

12. The system of claim 11, wherein the position determination unit is installed in the mobile communication device.

13. A method of determining a position of a building to which a mobile communication device belongs, comprising the steps of:
collecting first base station signal information with respect to each building;
storing and maintaining the collected first base station signal information in association with identification information of the buildings in a pattern matching database;
measuring second base station signal information received by the mobile communication device;
searching the pattern matching database by the second base station signal information to find a base station set similar to the second base station signal information; and
determining a position of a building corresponding to the found base station set as the position of the building to which the mobile communication device belongs in the case the property of the second base station signal information is corresponding to a predetermined property range of the found base station set.

14. The method of claim 13, wherein the predetermined property range of the base station set includes a pseudo-random noise phase delay range and a pseudo-random noise strength range.

15. The method of claim 14, wherein:
the pseudo-random noise phase delay range is determined within a predetermined range including a minimum value and a maximum value of the pseudo-random noise phase delays of base stations in the base station set, and
the pseudo-random noise strength is determined within a predetermined range including a minimum value and a maximum value of the pseudo-random noise strengths of base stations in the base station set.

16. The method of claim 13, wherein the pattern matching database is updated by newly collected base station signal information and the updated base station signal information (a′) is determined according to a′=w*a+(1−w)*b (a: existing base station information, b: newly collected base station information, and w is a weight more than 0 and less than 1).

17. A system for determining a position of a building to which a mobile communication device belongs, comprising:
a data collection unit collecting first base station signal information with respect to each building;
a pattern matching database storing the collected first base station signal information in association with an address of the building;
a signal measurement unit measuring second base station signal information received by the mobile communication device;
a base station set search unit searching the pattern matching database by the second base station signal information to find a base station set similar to the second base station signal information; and
a position determination unit determining a position of a building corresponding to the found base station set as the position of the building to which the mobile communication device belongs in the case the property of the second base station signal information is corresponding to a predetermined property range of the found base station set

18. A computer readable recording medium in which a program for executing the method of claim 1 is recorded.
